(19) United States
(12) Patent Application Publication
(10) Pub. No.: US 2019/0180341 A1
(43) Pub. Date: Jun. 13, 2019

(54) METHOD AND PROCESS FOR SELLING, GIFTING AND REDEEMING SUBSCRIPTION BASED PRODUCTS VIA AN ONLINE MARKETPLACE

(71) Applicants: John A. Matra, Westport, CT (US); Jean M. Matra, Westport, CT (US)

(72) Inventors: John A. Matra, Westport, CT (US); Jean M. Matra, Westport, CT (US)

(21) Appl. No.: 15/836,834

(22) Filed: Dec. 9, 2017

(51) Int. Cl. G06Q 30/06

(52) U.S. Cl. CPC G06Q 30/0621; G06Q 30/0633

(57) ABSTRACT

This invention provides a unique method and process for selling, gifting and redeeming a subscription of certain products via an online marketplace. The method includes offering subscription based products for sale via an online retail store that utilizes an Announcement Package (either electronic or physical), whereby the Announcement Package enables recipients to activate their subscription using a unique activation code and order number. Once the recipient has activated their subscription, they can order products by redeeming installments or points associated with their subscription using a system that provides the recipient ultimate flexibility in managing their subscription, empowering them to customize each order based on his or her needs.

### BRIEF SUMMARY

This patent application describes a unique method and process for selling, gifting and redeeming a subscription of certain products via an online marketplace. The method includes offering subscription based products for sale via an online retail store that utilizes an Announcement Package (either electronic or physical), whereby the Announcement Package enables recipients to activate their subscription using a unique activation code and order number. Once the recipient has activated their subscription, they can order products by redeeming installments or points associated with their subscription using a system that provides the recipient ultimate flexibility in managing their subscription, empowering them to customize each order based on his or her needs.

### BACKGROUND

The advent of the Internet has led to the proliferation of various online marketplaces. Such online marketplaces are configured to allow consumers to purchase products and services from a variety of merchants, vendors and retailers from all around the world. A user who wishes to purchase a product can visit an online marketplace, place the product in an online shopping cart and then proceed to a checkout process where the user is prompted to pay for the product or service using one or more payment options. The checkout process usually includes additional steps such as providing a billing address, a shipping address and a re-confirmation of the order placed. Once the user confirms the order, a fulfillment process is initiated, wherein the ordered product is packed and thereafter shipped to the user. Users can also buy gifts in a similar fashion.

Often, when a person wants to buy a gift for a friend or a relative, he is much less certain about the specifics of what to give than he is when he is purchasing a good or service for himself. The gift-giver may not know the kind of gift that would suit the recipient's needs. Even when the gift-giver has an idea of the kind of gift to buy, perhaps the category of product or service, he/she may not be sure about the specifics of what to get. He may not know the size, type, quantity, quality or timing of the product required or preferred by the recipient. As an example, imagine if a person wanted to buy a “Year's Supply of Diapers” for a relative or friend who is expecting or just had a baby. The purchaser (gift-giver) would not know which brand, type or size of diapers to buy. To some extent, even the recipient would not know which diapers would be needed. There are too many variables at play for the recipient to know what will suit that baby best several months or a whole year in advance. Yet, the gift-giver would still like to purchase and give that Year's Supply of Diapers today, before the child has been born. Likewise, the recipient would like to register for and receive that Year's Supply of Diapers before the baby has been born. Today's online retailers or marketplaces lack the flexibility required in cases like this—cases where they must sell a gift of products that will be consumed on a regular basis by the recipient, where the recipient will need to make periodic choices and changes regarding the product to be consumed, and where these choices and changes will be made by the recipient after the gift of products has already been paid for by the gift-giver. In other words, the gift giver wants to give a gift that will be redeemed in installments, but allow for each installment to be different, and to have a different economic value in relation to the total gift, as per the choices of the recipient. Right now, the model within the marketplace is such that installments of equal value are shipped on a monthly basis. For example, most subscriptions operate on the basis of a blind box where the shipper makes all of the decisions regarding the inclusions in the box and thereby determines its value. With the blind box model, the recipient does not specifically choose what they receive in the box, as contrasted with the type of choice they would need to exercise in the Year of Diapers scenario. Other subscriptions often feature a single brand of product so that, again, the shipper can equalize the value of all shipments. But what if you wanted to give a subscription wherein the recipient exercised a wider range of choice regarding what he received and when he received it? What if within that example of A Year of Diapers, the recipient could choose from a wide variety of brands and configurations, each one of a different value than the others, but ultimately all installments combining to satisfy the pre-paid gift of the purchaser? What if you wanted to allow the purchaser to prepay that sort of gift one time but enable the recipient to make choices about the manner and timeframe within which they redeemed that gift?

The authors of this patent application, John and Jean Matra (husband and wife) recognized that there is a need for a more efficient system through which consumers could purchase and gift such an online subscription service for products—one that would provide the recipient more flexibility in managing their subscription, empowering the recipient to customize each installment based on his or her needs. John and Jean Matra have developed such a system and currently operate an online business called IncrediBundles.com where consumers can purchase, gift and redeem subscriptions for certain types of products such as A Year of Diapers.

### DETAILED DESCRIPTION

This patent application describes a unique method and system for selling, gifting and redeeming a subscription of certain products via an online marketplace. The method includes activating, by a client device (e.g., computer, tablet, mobile phone), a subscription service using a unique activation code and order number and then ordering products by redeeming installments or points associated with that subscription. Let's use the example above where a consumer wishes to gift someone a Year's Supply of Diapers. A consumer (gift giver) should be able to visit an online store, purchase “A Year of Diapers” subscription and have it sent to the recipient. The purchaser should not have to worry about picking the brand, type or size of diapers or when they need to be delivered. When the “Year of Diapers” gift is shipped, the recipient would first receive an announcement package. The announcement package describes the gift and explains how to redeem the diapers. Included in the announcement package is a certificate that has a unique activation code and other information associated with the order. The recipient would then visit a website, create an online account and use the activation code and order number included in the announcement package to activate their diaper subscription. By activating the subscription, the recipient's account is credited with a certain number of installments or points which are used to place orders for products they want, when they need them. This process is different than receiving a generic gift card because the recipient is limited in what they can purchase. In this case, the recipient can only redeem diapers. However, they have complete freedom to choose which diapers (i.e., brand, type, size) and set the delivery schedule. For the purchaser of the gift, it provides assurance that the gift is being used for the intended purpose (to buy diapers). It would not be the same if the purchaser gave the recipient an Amazon gift card, for example, because there is no guarantee that the recipient will buy diapers with the gift card. As to the method of redemption, if the products being redeemed are all of relatively equal value, then the recipient will receive a certain number of installments. In the example above, the recipient would receive 12 installments. With each installment, the recipient would receive a month's supply of diapers. The recipient could redeem the installments on any schedule they choose. If the products being redeemed vary greatly in value, then the recipient will receive a certain number of points in their account once a subscription is activated. Each product available in the subscription would cost a different number of points. Therefore, the quantity of product redeemed is dependent on the value of the product selected. Importantly, the method and process of redeeming products via a subscription (either by installments or points) is streamlined because no payment is required. The products were already paid for by the gift giver. The example above (A Year's Supply of Diapers) is illustrative only. The same type of subscriptions can be used for any category of products (i.e., books, toys, clothes, food and more).

In order to manage the subscriptions, operations and provide customer support, there is a back-end application that allows administrators to modify any element described above (i.e., activation codes, installments, points, products, inventory, orders, etc.). For example, if a recipient loses their activation code, the administrator can void that code and issue a new one. The administrator is also able to run various types of reports, export data to common file formats and sync all data with a third-party CRM system.

### Underlying Software Technology

There are various software and web-based technologies that can be employed to accomplish the objectives described in this patent application. Therefore, the underlying technology is not the focus for this application. It is understood that the method and process for the invention is built on commonly used software and web-based technologies that will certainly change and be improved over time.

### DESCRIPTION OF THE DRAWINGS

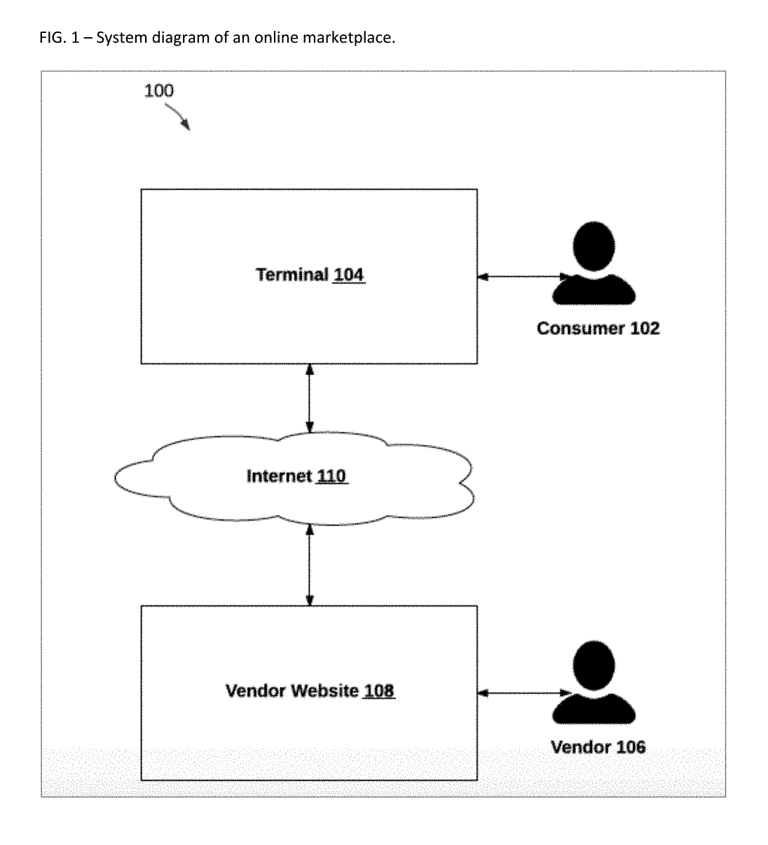

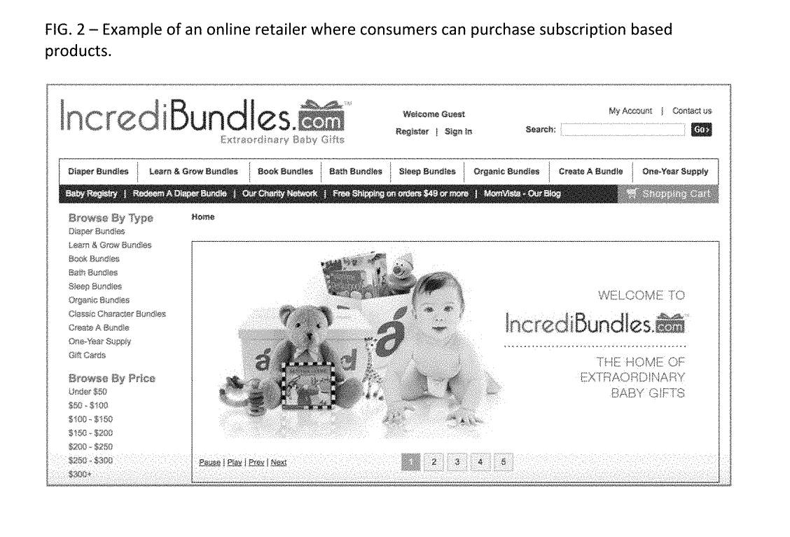

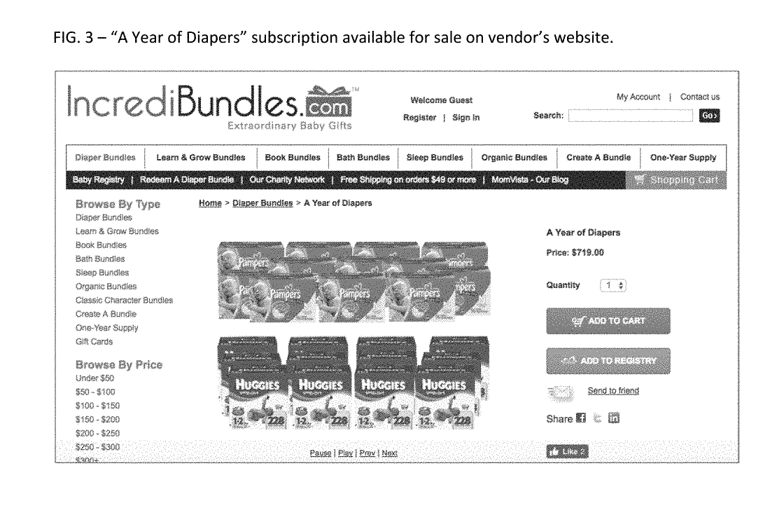

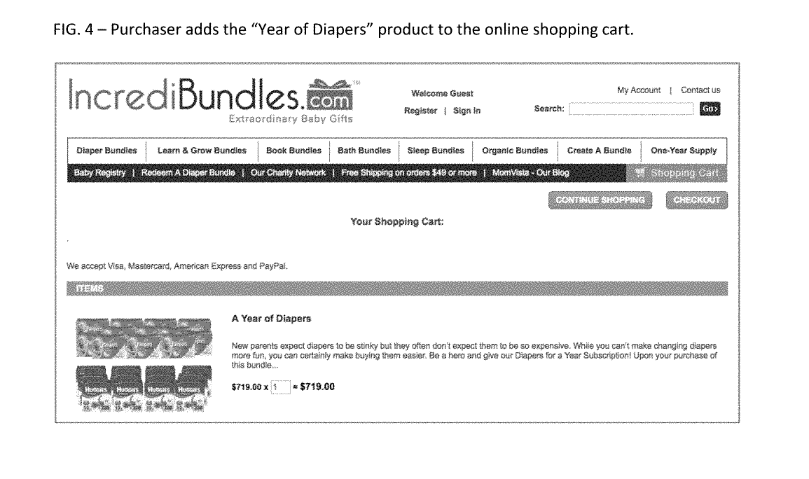

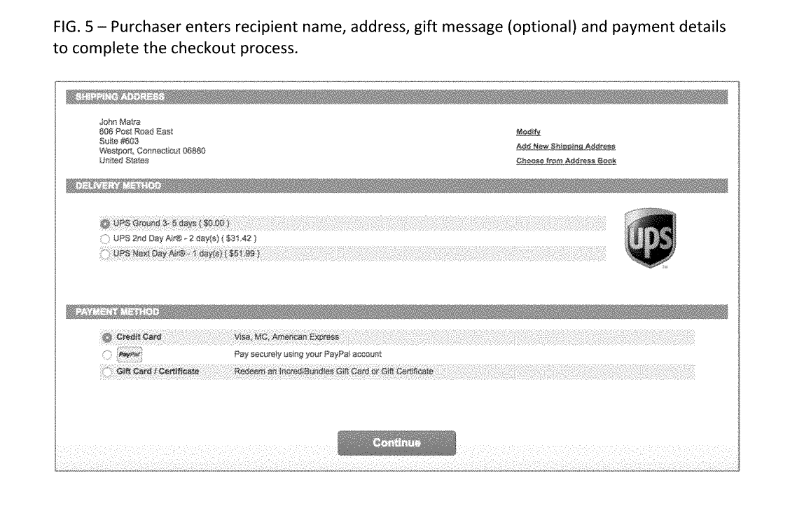

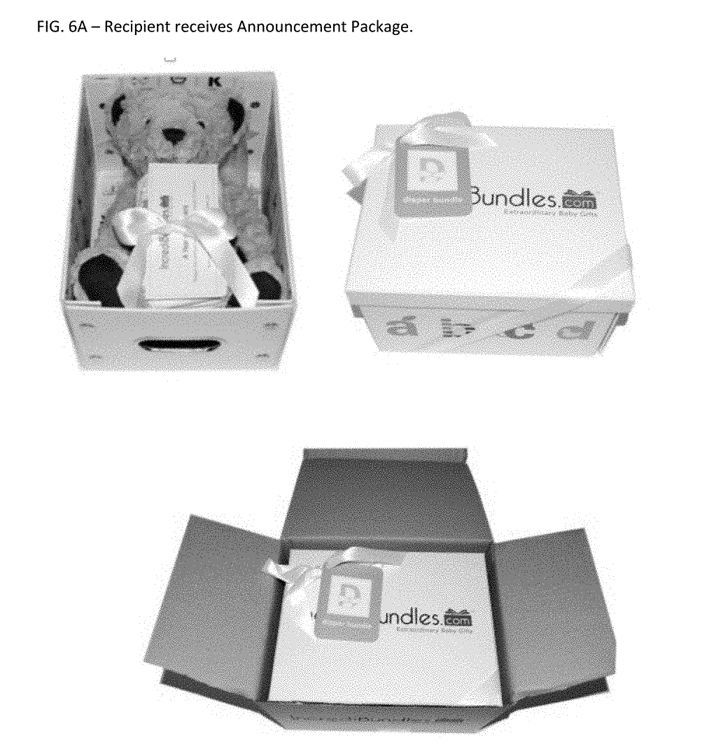

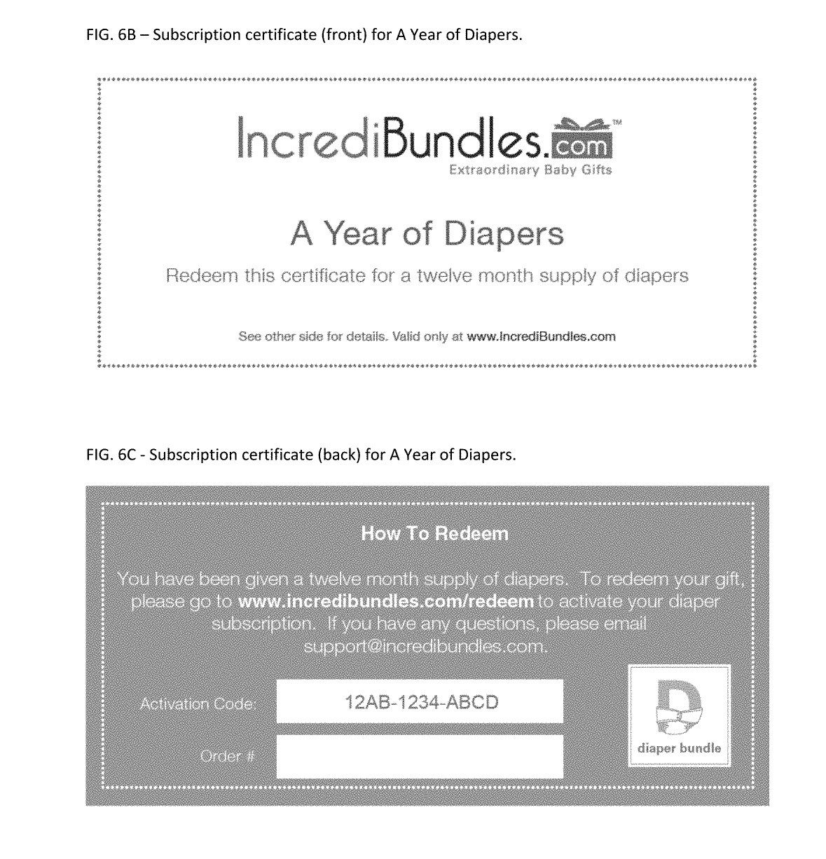

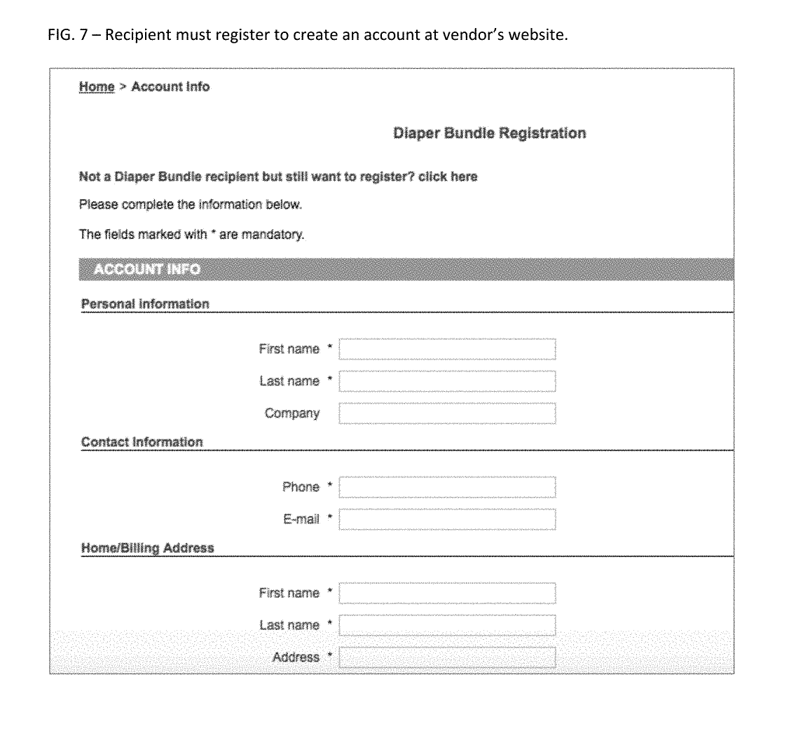

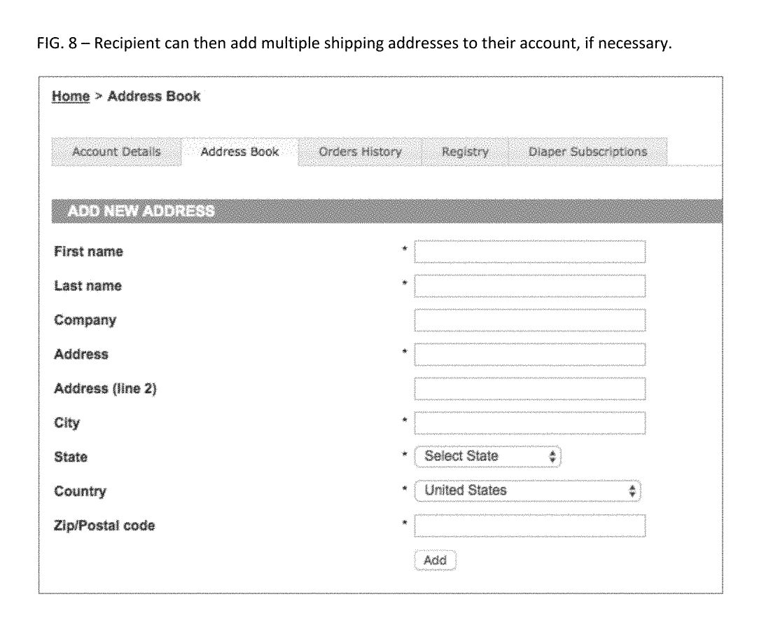

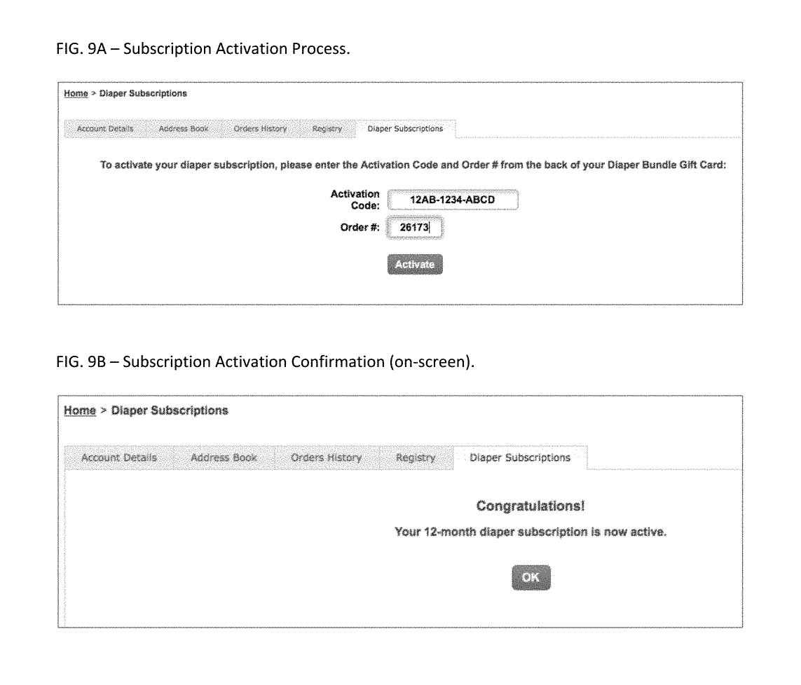

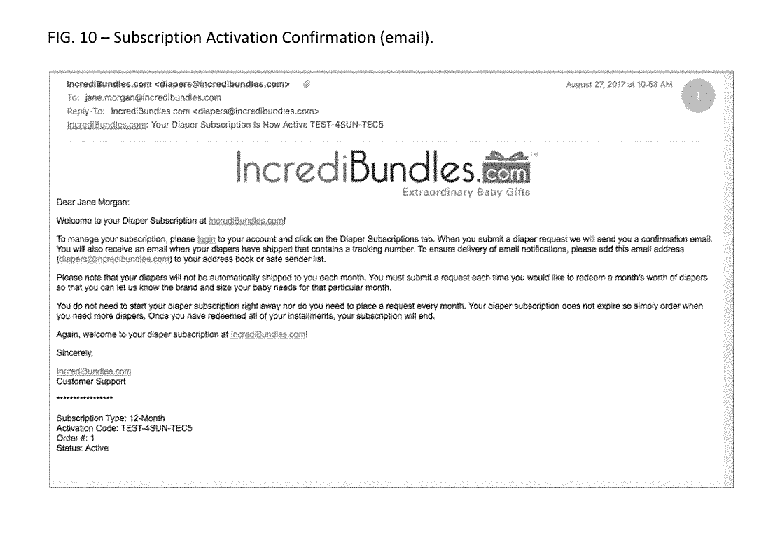

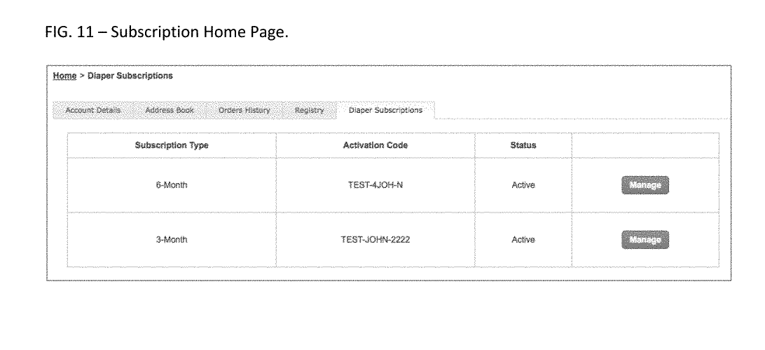

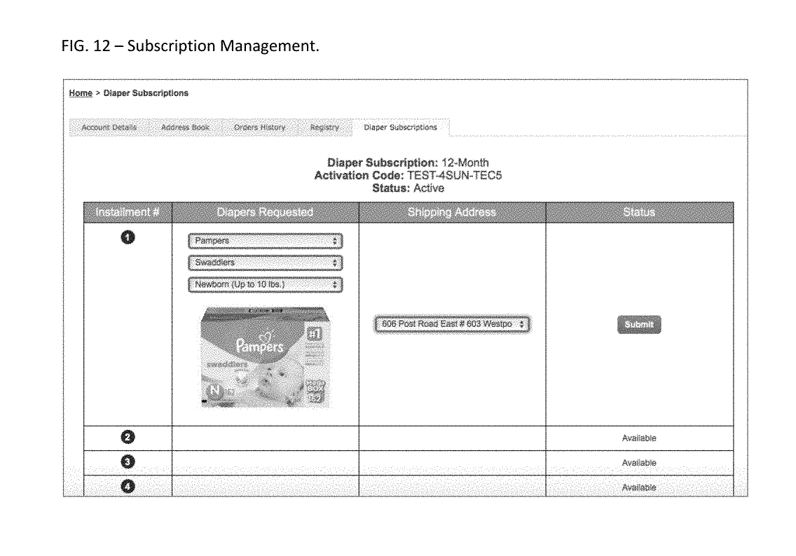

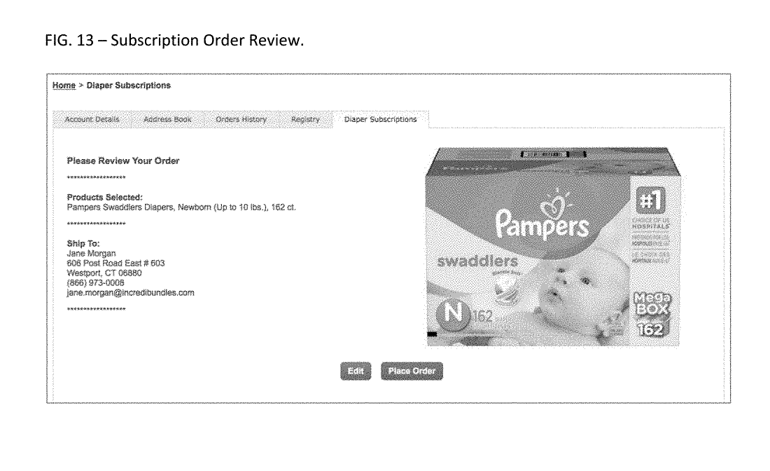

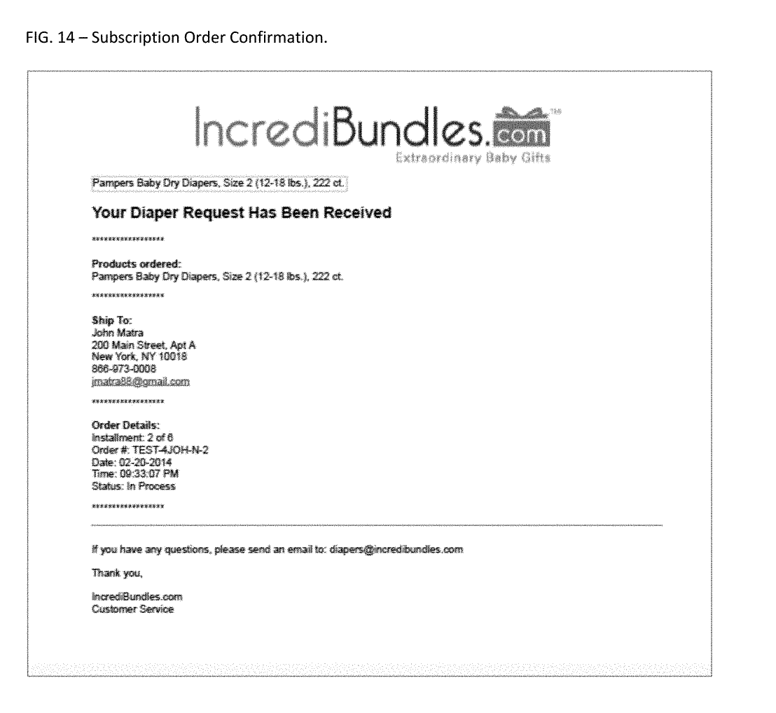

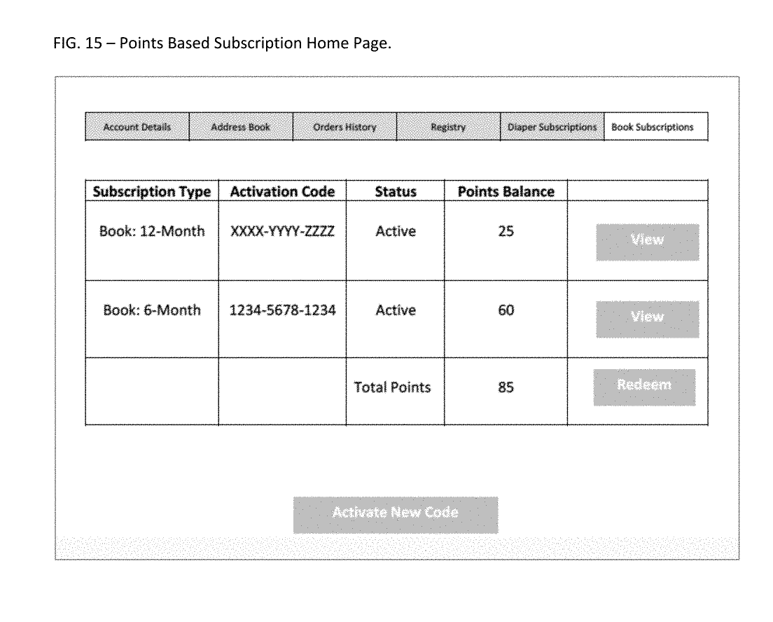

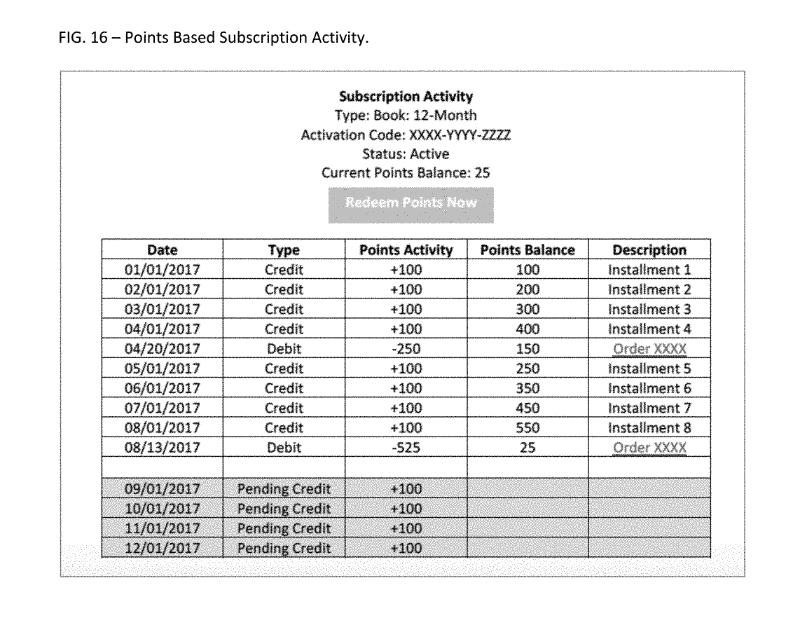

The accompanying drawings or depictions constitute a part of this patent application. They serve as exemplary embodiments and together with the descriptions below illustrate and further explain how the subscriptions work. It is intended that modifications, adaptations and other implementations are possible without departing from the spirit and scope of the claims outlined herein.

| | |
|---|---|
| FIG. 1 | For purposes of this application, an online marketplace includes a |
| | consumer, a terminal (such as a computer, tablet, mobile device, etc.), a |
| | vendor and a vendor website. Interaction between consumer and vendor |
| | is facilitated using the Internet. The consumer uses a commercially |
| | available Internet browser or mobile app to conduct a transaction, such as |
| | purchasing a product that is offered for sale by a vendor. |
| FIG. 2 | IncrediBundles.com is an example of a vendor website where consumers |
| | can purchase subscription based products as a gift for someone else. |
| FIG. 3 | “A Year of Diapers” is an example of a diaper subscription available for |
| | sale on the IncrediBundles.com website. |
| FIG. 4 | If a consumer wants to purchase “A Year of Diapers” they would add that |
| | product to the online shopping cart and begin the checkout process. |
| FIG. 5 | The purchaser completes the checkout process by entering their |
| | information, the recipient's name & address, a gift message (optional) and |
| | payment information. |
| FIG. 6A-C | Once the order is processed, IncrediBundles.com will ship the Year of |
| | Diapers “Announcement Package” to the recipient. The most important |
| | part of the Announcement Package is a certificate that contains a unique |
| | activation code and instructions for how to redeem the diapers. |
| FIG. 7 | The recipient must first register by creating an account at vendor website. |
| FIG. 8 | The recipient can add multiple shipping addresses to their account in the |
| | event that they want diapers shipped to different locations. |
| FIG. 9A-B | Recipient then uses the unique activation code and order number to |
| | activate their diaper subscription on the IncrediBundles.com website. If |
| | they enter the correct information, they will receive a message saying the |
| | activation was successful. If they enter incorrect information, they will |
| | receive an error message. |
| FIG. 10 | Upon activation, the recipient will also receive a confirmation email that |
| | contains the relevant information about their subscription. |
| FIG. 11 | The subscription home page displays a summary of each subscription |
| | activated by that user. The data includes the subscription type, activation |
| | code and status. Clicking the “Manage” button allows the recipient to |
| | redeem their diapers. |
| FIG. 12 | A Year of Diapers subscription would add twelve (12) installments to the |
| | recipient's account. Each installment enables the recipient to place one |
| | order. The recipient would use the drop-down menus to select the product |
| | brand, type, size and shipping address. If a user profile has more than |
| | one shipping address, then the user can choose to select one of the |
| | shipping addresses while placing the order. Clicking on the “Submit” |
| | button takes them to the order review page. Note, that in this illustration |
| | the recipient is placing an order for Installment # 1. Once that order has |
| | been placed, then they will see options to place an order for Installment # |
| | 2, and so on. The recipient can place orders at any time. The subscription |
| | is not based on time; therefore, it will end after all 12 installments have |
| | been redeemed regardless of how long the subscription has been active. |
| FIG. 13 | The order review page allows the user to review their order, make |
| | changes if necessary and then place their order by clicking on the green |
| | “Place Order” button. It is important to note that since the diapers were |
| | already paid for by the purchaser, the recipient does not need to pay for |
| | the diapers. The ordering process is more simplistic than a traditional |
| | online checkout because no payment method is required and the shipping |
| | address is already stored in their account. The user would repeat this step |
| | when they are ready to order another month's supply of diapers. The user |
| | would be able to place a total of 12 orders for A Year of Diapers, after |
| | which, the subscription will end. |
| FIG. 14 | Once the order has been placed, the user will receive an on-screen |
| | confirmation and email that contains all of the relevant information related |
| | to that order. That would be followed by a second email when the diapers |
| | ship that contains a tracking number. |
| FIG. 15 | A depiction of the Points based subscription home page. This is a |
| | summary page that displays each subscription type, activation code, |
| | status and points balance. The user can click “View” to see detailed |
| | information for each subscription (as shown below) or they can click on |
| | “Redeem” to order products using their points. |
| FIG. 16 | The points based subscription activity page displays detailed information |
| | regarding the “points activity” and “points balance” for each subscription. |
| | Much like a general ledger, the user can see point credits and debits to |
| | their account. It also displays “Pending” credits which will be credited to |
| | the account at a future date based on a schedule predetermined by the |
| | vendor or the type of subscription. For example, an annual “Book Club” |
| | Subscription might provide the user with 100 credits per month for 12 |
| | months. The user can only redeem the points which have been credited to |
| | their account as of that date. In the example below (shown as of |
| | Aug. 13, 2017), the user has been credited 100 points per month from January |
| | through August 2017. With each order placed, the number of points |
| | redeemed is deducted from the user's account and reflected in the |
| | summary of that subscription (as shown below on Apr. 20, 2017 and Aug. 13, 2017). |
| | The Pending credits will become active on the 1^{st} day of September, |
| | October, November and December. |

1. (canceled)

2. A gifting method performed by a computing device comprising a processor and a memory, said computing device in real-time communication with a communication network including a remote device operated by a gift giver and a remote device operated by a recipient, said computing device storing at least one of a recipient account and a gift giver account, said computing device having an interface to receive in real-time an order for a subscription gift generated by the gift giver operating the remote device of the gift giver and to receive in real-time a plurality of requests for redemption of the subscription gift generated by the recipient operating the remote device of the recipient, the method comprising the computing device:
receiving the order from the gift giver to purchase the subscription gift for the recipient, the subscription gift including one or more installments or points which are redeemable by the recipient at multiple times at the request of the recipient;
receiving an activation request including activation information from the recipient to activate the subscription gift;
in response to the activation request, validating in real-time the activation information received to activate the subscription gift, crediting the one or more installments or points to the recipient account, and transmitting the activation results in real-time to the interface of the remote device of the recipient; and
for each of a plurality of times the recipient requests redemption,
i) performing a real-time check of product availability;
ii) receiving a selection of an available product selected by the recipient;
iii) performing a real-time check of the account of recipient account to determine a balance of installments or points;
iv) receiving a redemption request from the recipient to redeem the selected product for an equivalent installment or number of credited points available from the determined balance; and
v) in response to the redemption request, debiting the recipient account balance by the installments or amount of points redeemed and generating an updated recipient account balance; and
vi) transmitting redemption information and the updated recipient account balance information in real-time to the interface of the remote device of the recipient.

3. The method according to claim 2, wherein:
the selected product is selected only from a preselected group of products associated with the subscription gift.

4. (canceled)

5. The method according to claim 2, wherein the respective number of installments or points redeemed in each redemption is the same or is variable.

6.-8. (canceled)

9. A gifting system comprising:
a computing device comprising a processor and a memory, said computing device in real-time communication with a communication network including a remote device operated by a gift giver and a remote device operated by a recipient, said computing device storing at least one of a recipient account and a gift giver account, said computing device having an interface to receive in real-time an order for a subscription gift generated by the gift giver operating the remote device of the gift giver and to receive in real-time a plurality of requests for redemption of the subscription gift generated by the recipient operating the remote device of the recipient; and
an application stored in the memory and executable by the processor to cause the computing device to:
receive the order from the gift giver to purchase the subscription gift for the recipient, the subscription gift including one or more installments or points which are redeemable by the recipient at multiple times at the request of the recipient;
receive an activation request including activation information from the recipient to activate the subscription gift;
in response to the activation request, validate in real-time the activation information received to activate the subscription gift credit the one or more installments or points to the recipient account, and transmit the activation results in real-time to the interface of the remote device of the recipient; and
for each of a plurality of times the recipient requests redemption,
vii) perform a real-time check of product availability;
viii) receive a selection of an available product selected by the recipient;
ix) perform a real-time check of the account of recipient account to determine a balance of installments or points;
x) receive a redemption request from the recipient to redeem the selected product for an equivalent installment or number of credited points available from the determined balance; and
xi) in response to the redemption request, debit the recipient account balance by the installment or amount of points redeemed and generate an updated recipient account balance; and
xii) transmit redemption information and the updated recipient account balance information in real-time to the interface of the remote device of the recipient.

10. The system according to claim 9, wherein:
the selected product is selected only from a preselected group of products associated with the subscription gift.

11. (canceled)

12. The system according to claim 9, wherein the respective number of installments or points redeemed in each redemption is the same or is variable.

13.-15. (canceled)

16. A non-transitory computer-readable medium embodying a program executable in at least one computing device comprising a processor and a memory, the computing device in real-time communication with a communication network including a remote device operated by a gift giver and a remote device operated by a recipient, said computing device storing at least one of a recipient account and a gift giver account, said computing device having an interface to receive in real-time an order for a subscription gift generated by the gift giver operating the remote device of the gift giver and to receive in real-time a plurality of requests for redemption of the subscription gift generated by the recipient operating the remote device of the recipient, wherein when the program is executed, the program causes the at least one computing device to:
receive the order from the gift giver to purchase the subscription gift for the recipient, the subscription gift including one or more installments or points which are redeemable by the recipient at multiple times at the request of the recipient;
receive an activation request including activation information from the recipient to activate the subscription gift;
in response to the activation request, validate in real-time the activation information received to activate the subscription gift credit the one or more installments or points to the recipient account, and transmit the activation results in real-time to the interface of the remote device of the recipient; and
for each of a plurality of times the recipient requests redemption,
i) perform a real-time check of product availability;
ii) receive a selection of an available product selected by the recipient;
iii) perform a real-time check of the account of recipient account to determine a balance of installments or points;
iv) receive a redemption request from the recipient to redeem the selected product for an equivalent installment or number of credited points available from the determined balance;
v) in response to the redemption request, debit the recipient account balance by the installment or amount of points redeemed and generate an updated recipient account balance; and
vi) transmit redemption information and the updated recipient account balance information in real-time to the interface of the remote device of the recipient.

17. The non-transitory computer-readable medium according to claim 16, wherein:
the selected product is selected only from a preselected group of products associated with the subscription gift.
group of goods for purchase with the redeemed points; and

18. (canceled)

19. The non-transitory computer-readable medium according to claim 16,
wherein the respective number of installments or points redeemed in each redemption is the same or is variable.

20.-22. (canceled)

23. The method according to claim 2, wherein the method further includes the computing device, in response to each redemption, validating and debiting, in real-time, the account of the gift giver by a monetary amount corresponding to the number of installments or points redeemed by the recipient.

24. The method according to claim 2, wherein the redemption times are periodic or variable based upon recipient preference, each redemption initiated by the recipient remote device and transmitted to the main computing device in real-time.

25. The system according to claim 9, wherein the computing device is also caused to:
in response to each redemption, validate and debit in real-time the account of the gift giver by a monetary amount corresponding to the number of installments or points redeemed by the recipient.

26. The system according to claim 9, wherein the redemption times are periodic or variable based upon recipient preference, each redemption request being initiated by the remote device of the recipient and transmitted to the computing device through the communication network in real-time.

27. The non-transitory computer-readable medium according to claim 16, wherein the program causes the at least one computing device to, in response to each redemption, validate and debit in real-time the account of the gift giver by a monetary amount corresponding to the number of installments or points redeemed by the recipient.

28. The non-transitory computer-readable medium according to claim 16, wherein the redemption times are periodic or variable based upon recipient preference, each redemption request being initiated by the remote device of the recipient and transmitted to the computing device through the communication network in real-time.
